(19) United States
(12) Patent Application Publication
(10) Pub. No.: US 2015/0120793 A1
(43) Pub. Date: Apr. 30, 2015

(54) MANAGING DEVICE OF DISTRIBUTED FILE SYSTEM, DISTRIBUTED COMPUTING SYSTEM THEREWITH, AND OPERATING METHOD OF DISTRIBUTED FILE SYSTEM

(71) Applicant: SAMSUNG ELECTRONICS CO., LTD., Suwon-si (KR)

(72) Inventor: Jae-Ki HONG, Hwasung-city (KR)

(73) Assignee: SAMSUNG ELECTRONICS CO., LTD., Suwon-si (KR)

(21) Appl. No.: 14/514,682

(22) Filed: Oct. 15, 2014

(30) Foreign Application Priority Data
Oct. 24, 2013 (KR) 10-2013-0127423

(51) Int. Cl. G06F 17/30; H04L 12/911; H04L 29/08

(52) U.S. Cl. CPC G06F 17/30203; H04L 67/1097; H04L 47/783
USPC 707/827

(57) ABSTRACT

Provided is a distributed computing system, which includes a plurality of slave devices configured to dispersively store each of a plurality of data blocks; a master device configured to divide data into the plurality of data blocks, to manage distributed storage information about the plurality of data blocks, and to process an access request; and an optimization device configured to calculate a target value of each of at least one performance parameter, wherein the target value sets an operation environment with a target performance, and the target value is calculated by repeatedly changing a value of each of the at least one performance parameter until the operation environment with the target performance is set.

### CROSS-REFERENCE TO RELATED APPLICATION

This U.S. non-provisional patent application claims priority from Korean Patent Application No. 10-2013-0127423, filed on Oct. 24, 2013, in the Korean Intellectual Property Office, the entire disclosure of which are incorporated herein by reference.

### BACKGROUND

1. Technical Field

Exemplary embodiments relate to a distributed file system. In particular, exemplary embodiments relate to a device for managing a distributed file system by improving an operation environment and operation performance of the distributed file system, a distributed computing system therewith, and an operating method of a distributed file system.

2. Description of the Related Art

In the related art, a device for computation, such as a computer, usually includes a storage device for storing data. Data is stored in a form of a file in a storage device. Various types of file systems are used to store data. In the related art, a distributed file system (DFS) has been developed for effectively storing and managing data having a large size. When a DFS is used, data having a large size is divided into a plurality of data blocks, and each data block is stored in each of a plurality of storage devices. In other words, data having a large size is divided into files, wherein each file has small volume, and each of the files is dispersively stored.

There are various kinds of DFS in the related art, including a Hadoop distributed file system (HDFS). The HDFS has a master-slave structure. A data node is a slave of the HDFS. The data node stores each file which is divided to have small volume. A name node is a master of HDFS. The name node manages dispersively-stored files and controls an access request of a client. In most cases in the related art, there is one name node. However, a plurality of data nodes is needed to store data dispersively. The dispersively-stored files are processed in parallel by a MapReduce process.

Since the HDFS processes in the related art dispersively-stored files in parallel, data may be rapidly processed. When the HDFS is used, one or more data nodes may be easily added, replaced, or removed without interruption of a system. In particular, when one or more data nodes are added, operation performance of a system is improved and a storage capacity of the system increases. When the HDFS is used, one data block is copied into a plurality of data blocks such that the data blocks are dispersively stored in a plurality of data nodes. Thus, even though interruption occurs in some data nodes of the related art HDFS, an operation of an overall system does not be interrupted. However, when interruption occurs in the sole name node of the related art HDFS, an operation of a system may be interrupted.

The related art HDFS includes about 180 configurable parameters. As the HDFS is improved, complexity of parameters continuously increases. A system manager has to manually set values of configurable parameters by considering an operation environment of a system to manage and improve operation performance of the HDFS. In order to properly set the values of the parameters, a system manager is required who has sufficient experience and understanding of a structure of the HDFS and a processing target data. High complexity in the management of a system operation performance is one of the drawbacks of the related art HDFS.

### SUMMARY

One or more exemplary embodiments may provide a distributed computing system, which may drive a distributed file system configured to divide data into a plurality of data blocks to dispersively store each data block dispersively. The distributed computing system may comprise a plurality of slave devices, at least one slave device of the plurality of slave devices is configured to perform a first operation to dispersively store each of the plurality of data blocks ; a master device configured to perform a second operation to divide the data into the plurality of data blocks, to provide each of the plurality of data blocks to each of the at least one slave device, to manage distributed storage information about the plurality of data blocks, and to process an access request, provided from a client, with respect to the data; and an optimization device configured to calculate a target value of each of at least one performance parameter of the master device and each of the plurality of slave devices, the target value sets operation environment with a target performance of the master device and each of the plurality of slave devices, the target value is calculated by repeatedly changing a value of each of the at least one performance parameter until the operation environment with the target performance is set.

One or more exemplary embodiments may also provide a device for managing a distributed file system configured to divide data into a plurality of data blocks to dispersively store each data block. The device may comprise a parameter managing module configured to manage a value of each of at least one performance parameter selected from at least one parameter, the at least one parameter setting an operation environment of the distributed file system; an optimization module configured to calculate a target value of each of the at least one performance parameter, the target value setting an operation environment with a target performance of the distributed file system, the target value calculated by repeatedly changing the value of each of the at least one performance parameter until the operation environment having the target performance is set; and an input and output module configured to provide information generated in the distributed file system to at least one of the parameter managing module and the optimization module, or to provide information generated in the at least one of the parameter managing module and the optimization module to the distributed file system.

One or more exemplary embodiments may also provide an operating method of a distributed file system configured to divide data into a plurality of data blocks to dispersively store each data block The operating method may comprise determining whether a process for changing an operation environment of the distributed file system is to be performed based on whether a desired condition is satisfied; calculating a target value of each of at least one performance parameter selected from among at least one parameter, the at least one parameter setting an operation environment of the distributed file system, the target value setting an operation environment with a target performance of the distributed file system, the target value calculated by repeatedly changing a value of each of the at least one performance parameter until the operation environment with the target performance is set, in response to determining that the process for changing the operation environment is to be performed; changing the operation environment of the distributed file system to the operation environment having the target performance based on the calculated target value, or generating information about the calculated target value.

### BRIEF DESCRIPTION OF THE DRAWINGS

Exemplary embodiments will be described below in more detail with reference to the accompanying drawings. The inventive concept may, however, be embodied in different forms and should not be constructed as limited to the embodiments set forth herein. Rather, these embodiments are provided so that this disclosure will be thorough and complete, and will fully convey the scope of the inventive concept to those skilled in the art Like numbers refer to like elements throughout the drawings.

FIG. 1 is a block diagram illustrating a distributed computing system in accordance with an exemplary embodiment.

FIG. 2 is a schematic diagram for explaining an operation process of a distributed computing system in accordance with an exemplary embodiment.

FIG. 3 is another schematic diagram for explaining an operation process of a distributed computing system in accordance with an exemplary embodiment.

FIG. 4 is still another schematic diagram for explaining an operation process of a distributed computing system in accordance with an exemplary embodiment.

FIG. 5 is a block diagram illustrating a device for managing distributed file system in accordance with another exemplary embodiment.

FIG. 6 is a schematic diagram for explaining an operation process of the device illustrated in FIG. 5, according to an exemplary embodiment.

FIG. 7 is another block diagram illustrating a device for managing distributed file system in accordance with another exemplary embodiment.

FIG. 8 is a schematic diagram for explaining an operation process of the device illustrated in FIG. 7, according to an exemplary embodiment.

FIG. 9 is still another block diagram illustrating a device for managing distributed file system in accordance with another exemplary embodiment.

FIG. 10 is a schematic diagram for explaining an operation process of the device illustrated in FIG. 9, according to an exemplary embodiment.

FIG. 11 is a flow chart illustrating an operating method of a distributed file system in accordance with still another exemplary embodiment.

FIG. 12 is another flow chart illustrating an operating method of a distributed file system in accordance with still another exemplary embodiment.

FIG. 13 is still another flow chart illustrating an operating method of a distributed file system in accordance with still another exemplary embodiment.

FIG. 14 is a flow chart for explaining a process being performed in a general mode and an optimization mode in accordance with exemplary embodiments.

FIG. 15 is a block diagram illustrating a cloud storage system adopting a distributed file system in accordance an exemplary embodiment.

### DETAILED DESCRIPTION OF THE EXEMPLARY EMBODIMENTS

The above-described characteristics and the following detailed description are merely examples for helping the understanding of the exemplary embodiments. That is, the exemplary embodiments may be embodied in different forms and should not be constructed as limited to the embodiments set forth herein. The following embodiments are merely examples for completely disclosing the exemplary embodiments and for delivering the exemplary embodiments to those skilled in the art. Therefore, in the case where there are multiple methods for implementing the elements of the exemplary embodiments, the exemplary embodiments may be implemented with any of the methods or an equivalent thereof.

When it is mentioned that a certain configuration includes a specific element or a certain process includes a specific step, another element or another step may be further included. In other words, the terms used herein are not for limiting the inventive concept, but for describing a specific embodiment. Furthermore, the embodiments described herein include complementary embodiments thereof.

The terms used herein have meanings that are generally understood by those skilled in the art. The commonly used terms should be consistently interpreted according to the context of the specification. Furthermore, the terms used herein should not be interpreted as overly ideal or formal meanings, unless the meanings of the terms are clearly defined.

In the following descriptions, it is assumed that a Hadoop distributed file system (HDFS) is used as a distributed file system (DFS). However, a technical spirit of the inventive concept may be applied to other kinds of DFS by one of ordinary skill in the art. For instance, a technical spirit of the inventive concept may be applied to not only Google File System (GFS) or a Cloud Store, which are similar to the HDFS, but also other DFS such as Coda, Network File System (NFS), General Parallel File System (GPFS), etc. The following description is for disclosing and helping the inventive concept , and is not for limiting the scope of the inventive concept. Hereinafter, the exemplary embodiments of the inventive concept will be described with reference to the accompanying drawings.

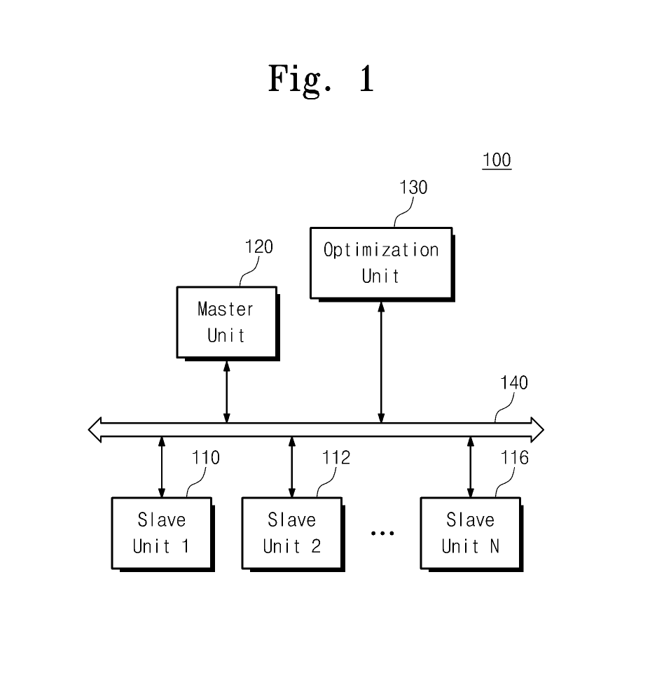

FIG. 1 is a block diagram illustrating a distributed computing system in accordance with an exemplary embodiment. A distributed computing system 100 may include a plurality of slave units 110, 112, and 116, a master unit 120, an optimization unit 130, and a network 140.

The slave units 110, 112, and 116 may store data. When the HDFS is used, data may be divided into a plurality of data blocks. Each data block may be dispersively stored in at least one of the slave units 110, 112, and 116. The slave units 110, 112, and 116 may perform a first operation, which is for driving the DFS, to store the data block. When the HDFS is used, a task tracker may be executed as the first operation in the slave units 110, 112, and 116.

The master unit 120 may divide the data into the plurality of data blocks. The master unit 120 may provide each data block to at least one of the slave units 110, 112 and 116. The master unit 120 may perform a second operation which is for driving the DFS. When the HDFS is used, a job tracker may be executed as the second operation in the master unit 120.

The master unit 120 may manage distributed storage information of the plurality of data blocks. When the HDFS is used, the master unit 120 may manage metadata which includes information of the data blocks stored in each of the slave units 110, 112, and 116. The master unit 120 may receive an access request, from a client, with respect to the data. The master unit 120 may extract location information of the slave units 110, 112, and 116 which are dispersively storing data that is a target of the access request. The location information may be extracted from the metadata. The master unit 120 may provide the extracted location information to the client which provided the access request with respect to the data. In other words, the master unit 120 may process the access request, received from the client, with respect to the data.

When the HDFS is used, an operation environment of the master unit 120 and each of the slave units 110, 112, and 116 may be set by one or more parameters included in the HDFS. The one or more parameters may include one or more performance parameters, which are related with operation performance of the HDFS. A change of a value of each of the one or more performance parameters may affect the operation performance of the HDFS.

The optimization unit 130 may change the value of each of the one or more performance parameters. In some exemplary embodiments, the optimization unit 130 may include a storage area (not shown). In these exemplary embodiments, the optimization unit 130 may store the value of each of the one or more performance parameters in the storage area in advance, may read the stored value, and then may change the read value. Alternatively, the optimization unit 130 may directly receive the value of each of the one or more performance parameters from at least one of the master unit 120 and the slave units 110, 112, and 116, and may change the received value as necessary.

The optimization unit 130 may determine whether an operation environment having target performance of the master unit 120 and each of the slave units 110, 112, and 116 is set by one or more performance parameters having the changed value. The optimization unit 130 may repeatedly change the value of each of the one or more performance parameters until the operation performance of the master unit 120 and each of the slave units 110, 112 and 116 reaches the target performance. If the operation performance of the master unit 120 and each of the slave units 110, 112 and 116 reaches the target performance by the one or more performance parameters having the changed value, the optimization unit 130 may calculate the value of each of the one or more performance parameters as a target value.

In some exemplary embodiments, the one or more performance parameters may include at least one parameter previously selected from among the one or more parameters. A system manager may select at least one parameter which is likely to affect the operation performance of the HDFS from among the one or more parameters. Then, the system manager may form a performance parameter pool including the selected parameter in advance. A value of the selected parameter included in the performance parameter pool may be changed by the optimization unit 130.

In some exemplary embodiments, the one or more performance parameters may include at least one parameter arbitrarily selected from among the one or more parameters by the optimization unit 130. The optimization unit 130 may arbitrarily select at least one parameter from among the one or more parameters. The arbitrarily selected parameter may be included in the performance parameter pool. The optimization unit 130 may perform some tests with respect to whether the operation performance of the HDFS is changed by changing the value of the arbitrarily selected parameter. If the operation performance of the HDFS is not changed by changing the value of the arbitrarily selected parameter, the arbitrarily selected parameter may be excluded from the performance parameter pool. If the operation performance of the HDFS is changed by changing the value of the arbitrarily selected parameter, the performance parameter pool may constantly include the arbitrarily selected parameter. Both the parameter previously selected by the system manager and the parameter arbitrarily selected by the optimization unit 130 from among the one or more parameters may be included in the performance parameter pool.

The optimization unit 130 may change the operation environment of the master unit 120 and each of the slave units 110, 112, and 116 based on the target value of the calculated one or more performance parameters. The changed operation environment is the operation environment having the target performance. In other words, the optimization unit 130 may apply the calculated performance parameters having the target value to the overall distributed computing system 100 to improve the operation environment of the master unit 120 and each of the slave units 110, 112, and 116.

In some exemplary embodiments, the optimization unit 130 may generate information of the calculated target value, instead of directly applying the calculated target value to the distributed computing system 100. The optimization unit 130 may generate a log file with respect to the calculated target value, and then may store the log file in the storage area. Alternatively, the optimization unit 130 may output a printed material or a pop-up message to report the calculated target value to the system manager. The optimization unit 130 may also generate the information of the calculated target value while applying the calculated target value to the distributed computing system 100.

Each of the slave units 110, 112, and 116, the master unit 120, and the optimization unit 130 may exchange information with one another through the network 140. Further, each of the slave units 110, 112, and 116, the master unit 120, and the optimization unit 130 may include at least one processor, a hardware module, or a circuit for performing their respective functions.

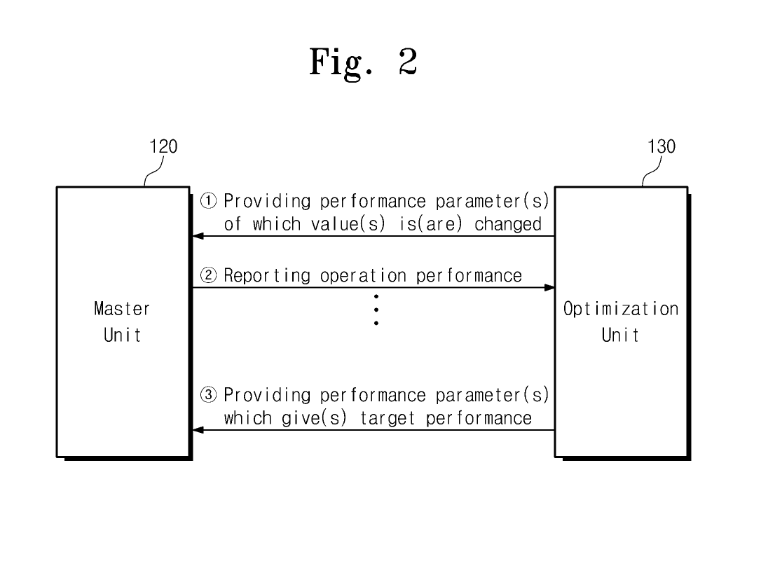

FIG. 2 is a schematic diagram for explaining an operation process of a distributed computing system in accordance with an embodiment. In particular, FIG. 2 describes a process in which the optimization unit 130 improves the operation environment of the master unit 120. However, the optimization unit 130 may also improve the operation environment of at least one of the slave units 110, 112, and 116. Alternatively, the optimization unit 130 may improve the operation environment of the master unit 120 and the slave units 110, 112, and 116 at the same time. In other words, FIG. 2 describes one exemplary embodiment in which the optimization unit 130 improves the operation environment of the master unit 120.

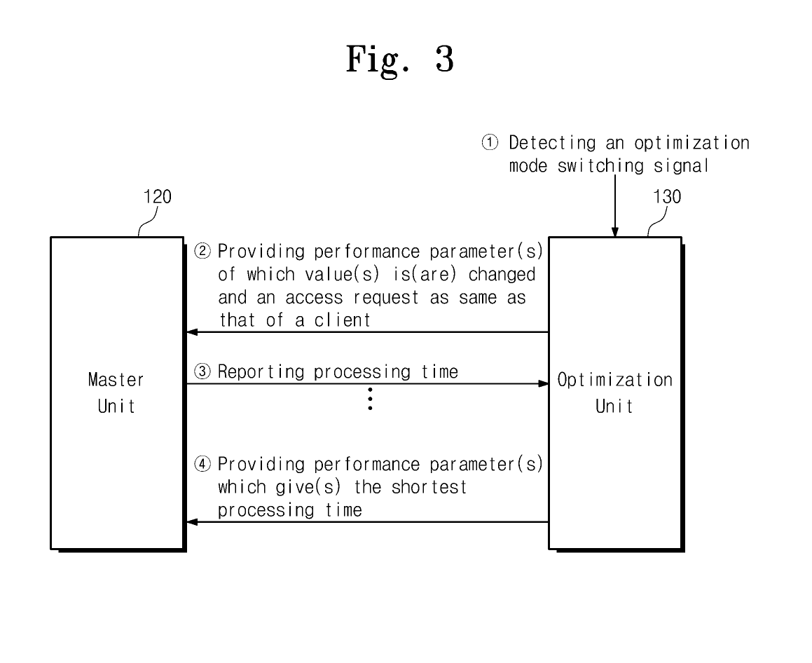

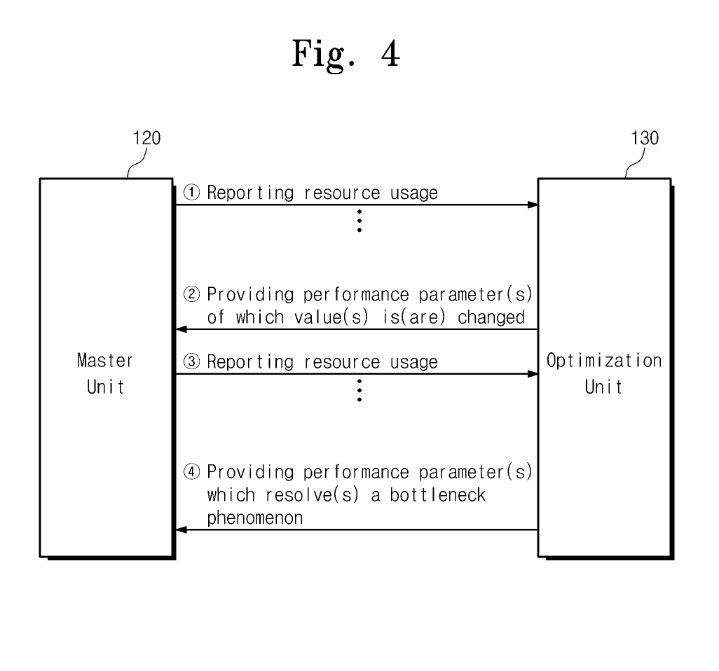

First, it may be determined whether a process for changing the operation environment of the master unit 120 is to be performed. Whether the process for changing the operation environment of the master unit 120 is to be performed may be determined based on whether a desired condition is satisfied. The desired condition may be satisfied when an optimization mode switching signal is detected. Alternatively, the desired condition may be satisfied when a bottleneck phenomenon occurs at the master unit 120. Some exemplary embodiments in relation to the desired condition will be further illustrated with reference to FIGS. 3 and 4.

When it is determined that the process for changing the operation environment of the master unit 120 is to be performed, the optimization unit 130 may change the value of each of the one or more performance parameters. Then, the optimization unit 130 may provide the changed value of each of the one or more performance parameters to the master unit 120 (process \textcircled{1}). The operation environment of the master unit 120 may be changed based on the one or more performance parameters provided to the master unit 120.

The master unit 120 may provide information in relation to the operation performance being obtained in the changed operation environment to the optimization unit 130 (process \textcircled{2}). The optimization unit 130 may determine whether the operation performance of the master unit 120 reaches the target performance based on the information in relation to the operation performance provided from the master unit 130. The target performance may be a performance in which the master unit 120 processes the access request provided from the client in a short time. Alternatively, the target performance may be a performance in which the master unit 120 processes the access request provided from the client without the bottleneck phenomenon. The processes \textcircled{1} and \textcircled{2} may be repeatedly performed until the operation performance of the master unit 120 reaches the target performance.

The optimization unit 130 may calculate the value of each of the one or more performance parameters that sets the operation environment having the target performance of the master unit 120 as the target value. The optimization unit 130 may provide the one or more performance parameters having the calculated target value to the master unit 120 (process \textcircled{3}). The operation environment of the master unit 120 may be changed based on the target value of each of the one or more performance parameters provided from the optimization unit 130. The master unit 120 may operate at the target performance in the changed operation environment. However, in some exemplary embodiments, the optimization unit 130 may generate the information of the calculated target value, instead of performing the process \textcircled{3}. Alternatively, the optimization unit 130 may generate the information of the calculated target value while the process \textcircled{3} is being performed.

FIG. 3 is another schematic diagram for explaining an operation process of a distributed computing system in accordance with an exemplary embodiment of the inventive concept. In particular, FIG. 3 describes an optimization mode in which the optimization unit 130 improves the operation environment of the master unit 120. However, the optimization unit 130 may also improve the operation environment of at least one of the slave units 110, 112, and 116. Alternatively, the optimization unit 130 may improve the operation environment of the master unit 120 and the slave units 110, 112, and 116 at the same time. In other words, FIG. 3 describes one exemplary embodiment in which the optimization unit 130 improves the operation environment of the master unit 120.

First, an optimization mode switching signal may be detected (process \textcircled{1}). The optimization mode switching signal is a signal for controlling the optimization unit 130 such that the optimization unit 130 operates in the optimization mode.

In some exemplary embodiments, the system manager may provide an optimization mode switching command to the distributed computing system 100 to improve the operation environment of the distributed computing system 100. The optimization mode switching signal may be generated according to the optimization mode switching command of the system manager. The optimization mode switching signal may be generated according to the optimization mode switching command provided from outside of the distributed computing system 100.

In some exemplary embodiments, the optimization mode switching signal may be generated when the access request with respect to the data is not provided from the client to the master unit 120 for a desired time. In other words, when the distributed computing system 100 does not operate for the desired time (e.g., an idle time occurs), the optimization mode switching signal may be generated.

The optimization unit 130 may collect information of the access request, provided from the client, with respect to the data. The optimization unit 130 may store the collected information of the access request in the storage area. When the optimization mode switching signal is detected, the optimization unit 130 may begin to operate in the optimization mode. In the optimization mode, the optimization unit 130 may change the value of each of the one or more performance parameters. Further, the optimization unit 130 may provide the changed value of each of the one or more performance parameters and the same access request as the access request, provided from the client, with respect to the data to the master unit 120 (process \textcircled{2}).

The operation environment of the master unit 120 may be changed based on the one or more performance parameters provided to the master unit 120. The master unit 120 may process the same access request as the access request provided from the client in the changed operation environment. The master unit 120 may provide information of a processing time of the same access request to the optimization unit 130 (process \textcircled{3}). The processes \textcircled{2} and \textcircled{3} may be repeatedly performed until the desired condition is satisfied. In other words, the same access request may be repeatedly processed in different operation environments of the master unit 120.

In some exemplary embodiments, the system manager may determine and set the value that each of the one or more performance parameters can have in advance. The processes \textcircled{2} and \textcircled{3} may be repeatedly performed until the same access request is processed in each and every operation environment of the master unit 120 of which each is differently set by the set value of each of the one or more performance parameters. In some exemplary embodiments, the system manager may determine and set a range of the value that each of the one or more performance parameters can have in advance. The processes \textcircled{2} and \textcircled{3} may be repeatedly performed until the same access request is processed in each and every operation environment of the master unit 120 of which each is differently set by values included in the set range.

The optimization unit 130 may calculate the target value of each of the one or more performance parameters based on the information of the processing time of the same access request. For instance, the operation environment corresponding to a case that the same access request is processed in the shortest time may be the operation environment having the target performance. The optimization unit 130 may calculate the value of each of the one or more performance parameters of the case that the same access request is processed in the shortest time as the target value. After the master unit 120 processes the same access request when the value of each of the one or more performance parameters is changed, the value may be calculated as the target value in which each of the one or more performance parameters of the case that the same access request is processed in the shortest time.

The optimization unit 130 may provide the one or more performance parameters having the calculated target value to the master unit 120 (process \textcircled{4}). Alternatively, the optimization unit 130 may generate the information of the calculated target value, instead of performing the process \textcircled{4}. The optimization unit 130 may generate the information of the calculated target value while the process \textcircled{4} is being performed.

The operation environment of the master unit 120 may be changed based on the target value of each of the one or more performance parameters. When the master unit 120 process the same access request in the changed operation environment, the access request may be processed in a short time. In other words, the operation environment of the master unit 120 may be improved based on the target value of each of the one or more performance parameters.

Before the optimization unit 130 operates in the optimization mode, different access requests, provided from the client, with respect to the data may occur several times. In this case, the optimization unit 130 may calculate the target values of each of the one or more performance parameters with respect to each of multiple access requests the same as each of the different access requests in the optimization mode.

In some exemplary embodiments, when the target values of each of the one or more performance parameters with respect to each of the different access requests are all calculated, the optimization unit 130 may stop an operation in the optimization mode and may begin to operate in a general mode. In some exemplary embodiments, when another access request with respect to the data is provided from the client while the optimization unit 130 is being operating in the optimization mode, the optimization unit 130 may stop an operation in the optimization mode and may begin to operate in the general mode.

When the access request with respect to the data is provided from the client, the optimization unit 130 may determine whether the target value of each of the one or more performance parameters with respect to the provided access request is calculated. If the target value is calculated, the optimization unit 130 may provide the one or more performance parameters having the calculated target value to the master unit 120 to change the operation environment of the master unit 120. The master unit 120 may rapidly process the access request, provided from the client, with respect to data in the changed operation environment.

FIG. 4 is still another schematic diagram for explaining an operation process of a distributed computing system in accordance with an embodiment. In particular, FIG. 4 describes a process in which the optimization unit 130 resolves the bottleneck phenomenon of the master unit 120. However, the optimization unit 130 may also improve the operation environment of at least one of the slave units 110, 112, and 116. Alternatively, the optimization unit 130 may improve the operation environment of the master unit 120 and the slave units 110, 112, and 116 at the same time. In other words, FIG. 4 describes one exemplary embodiment in which the optimization unit 130 improves the operation environment of the master unit 120.

First, the master unit 120 may provide information of resource usage to the optimization unit 130 (process \textcircled{1}). In some exemplary embodiments, the resource usage may include a processor usage, a memory usage, and a transmission traffic rate through the network 140. The optimization unit 130 may periodically collect the information of the resource usage of the master unit 120 while the access request, provided from the client, with respect to the data is being processed. The optimization unit 130 may monitor whether the bottleneck phenomenon occurs in the master unit 120 based on the collected information of the resource usage. For instance, if a processor of the master unit 120 is completely used but a memory of the master unit 120 and/or the network 140 is partially used, the processor of the master unit 120 may be determined to be a bottleneck point. If it is determined that the bottleneck point exists, it may be determined that the bottleneck phenomenon occurs. The process \textcircled{1} may be repeatedly performed until it is determined that the bottleneck phenomenon occurs.

If it is determined that the bottleneck phenomenon occurs, the optimization unit 130 may change the value of each of the one or more performance parameters. The optimization unit 130 may provide the changed value of each of the one or more performance parameters to the master unit 120 (process \textcircled{2}). The operation environment of the master unit 120 may be changed based on the changed value of each of the one or more performance parameters provided to the master unit 120.

The master unit 120 may provide the information of the resource usage obtained in the changed operation environment to the optimization unit 130 (process \textcircled{3}). The optimization unit 130 may determine whether the bottleneck phenomenon which occurs in the master unit 120 is resolved based on the provided information of the resource usage. The processes \textcircled{2} and \textcircled{3} may be repeatedly performed until the bottleneck phenomenon which occurs in the master unit 120 is resolved.

The optimization unit 130 may calculate the target value of each of the one or more performance parameters based on the provided information of the resource usage. For instance, the operation environment corresponding to a case that the bottleneck phenomenon is resolved may be the operation environment having the target performance. The optimization unit 130 may calculate the value of each of the one or more performance parameters of the case that the bottleneck phenomenon which occurs in the master unit 120 is resolved as the target value. The optimization unit 130 may provide the one or more performance parameters having the calculated target value to the master unit 120 (process \textcircled{4}).

The operation environment of the master unit 120 may be improved based on the target value of each of the one or more performance parameters provided to the master unit 120. In other words, the bottleneck phenomenon which occurs in the master unit 120 may be resolved based on the target value of each of the one or more performance parameters. Alternatively, the optimization unit 130 may generate the information of the calculated target value, instead of performing the process \textcircled{4}. The optimization unit 130 may generate the information of the calculated target value while the process \textcircled{4} is being performed.

In FIGS. 1 to 4, the distributed computing system 100 in which the slave units 110, 112, and 116, the master unit 120, and the optimization unit 130 are embodied by separate respective elements. However, this embodiment is just exemplary. As necessary, each of the slave units 110, 112, and 116, the master unit 120, and the optimization unit 130 may be embodied by being combined with another element. For instance, the optimization unit 130 may be embodied with the master unit 120 in the same device. Alternatively, the slave units 110, 112, and 116, the master unit 120, and the optimization unit 130 may be embodied by more subdivided elements according to their respective functions.

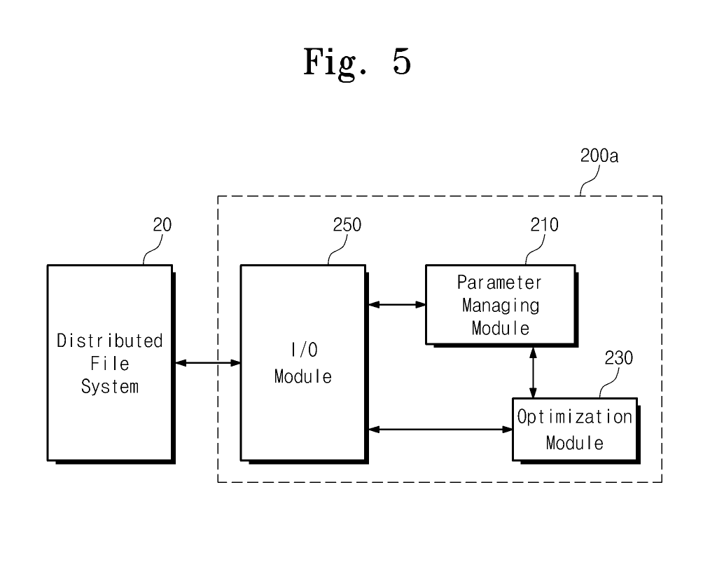

FIG. 5 is a block diagram illustrating a device for managing distributed file system in accordance with another embodiment. A distributed file system managing device 200a may include a parameter managing module 210, an optimization module 230, and an input/output module 250.

The distributed file system managing device 200a may communicate with a distributed file system (DFS) 20. An operation environment of the DFS 20 may be set by one or more parameters. The one or more parameters may include one or more performance parameters, which are related with operation performance of the DFS 20. A change of a value of each of the one or more performance parameters may affect the operation performance of the DFS 20.

The parameter managing module 210 may manage the value of each of the one or more performance parameters. In some exemplary embodiments, the parameter managing module 210 may include a storage area (not shown). In these exemplary embodiments, the parameter managing module 210 may store the value of each of the one or more performance parameters in the storage area in advance. Alternatively, the parameter managing module 210 may receive the value of each of the one or more performance parameters from the DFS 20 as necessary.

The optimization module 230 may change the value of each of the one or more performance parameters. In some exemplary embodiments, the optimization module 230 may read the value of each of the one or more performance parameters stored in the parameter managing module 210, and then may change the read value. Alternatively, the optimization module 230 may receive the value of each of the one or more performance parameters through the parameter managing module 210, and then may change the received value.

The optimization module 230 may determine whether an operation environment having target performance of the DFS 20 is set by one or more performance parameters having the changed value. The optimization module 230 may repeatedly change the value of each of the one or more performance parameters until it is determined that the operation performance of the DFS 20 reaches the target performance. If it is determined that the operation performance of the DFS 20 reaches the target performance by the one or more performance parameters having the changed value, the optimization module 230 may calculate the value of each of the one or more performance parameters that sets the operation environment having the target performance as a target value.

In some exemplary embodiments, the one or more performance parameters may include at least one parameter previously selected from among the one or more parameters. A system manager may select at least one parameter which is likely to affect the operation performance of the DFS 20 from among the one or more parameters. Then, the system manager may form a performance parameter pool including the selected parameter in advance. A value of each performance parameter included in the performance parameter pool may be changed by the optimization module 230.

In some exemplary embodiments, the one or more performance parameters may include at least one parameter arbitrarily selected from among the one or more parameters by the optimization module 230. The optimization module 230 may arbitrarily select at least one parameter from among the one or more parameters. The arbitrarily selected parameter may be included in the performance parameter pool. The optimization module 230 may perform a plurality of tests with respect to whether the operation performance of the DFS 20 is changed by changing the value of the arbitrarily selected parameters. If the operation performance of the DFS 20 is not changed by changing the value of the arbitrarily selected parameters, the arbitrarily selected parameter may be excluded from the performance parameter pool. If the operation performance of the DFS 20 is changed by changing the value of the arbitrarily selected parameter, the performance parameter pool may always include the arbitrarily selected parameter in the performance parameter pool. Both of the parameter previously selected by the system manager and the parameter arbitrarily selected by the optimization module 230 from among the one or more parameters may be included in the performance parameter pool.

The optimization module 230 may change the operation environment of the DFS 20 based on the target value of the calculated one or more performance parameters. The changed operation environment is the operation environment having the target performance. In other words, the optimization module 230 may apply the calculated performance parameters having the target value to the overall DFS 20 to improve the operation environment of the DFS 20.

In some exemplary embodiments, the optimization module 230 may generate information of the calculated target value, instead of directly applying the calculated target value to the DFS 20. The optimization module 230 may generate a log file with respect to the calculated target value, and then may store the log file in a storage area (not shown). The storage area for storing the log file may be included in at least one of the parameter managing module 210 and the optimization module 230. Alternatively, the optimization module 230 may output printed material or a pop-up message to report the calculated target value to the system manager. The optimization module 230 may generate the information of the calculated target value while applying the calculated target value to the DFS 20.

The input/output module 250 is en element for transferring information provided to the distributed file system managing device 200a and information generated in the distributed file system managing device 200a. The input/output module 250 may provide information generated in the DFS 20 to at least one of the parameter managing module 210 and the optimization module 230. The input/output module 250 may also provide the information generated in at least one of the parameter managing module 210 and the optimization module 230 to the DFS 20.

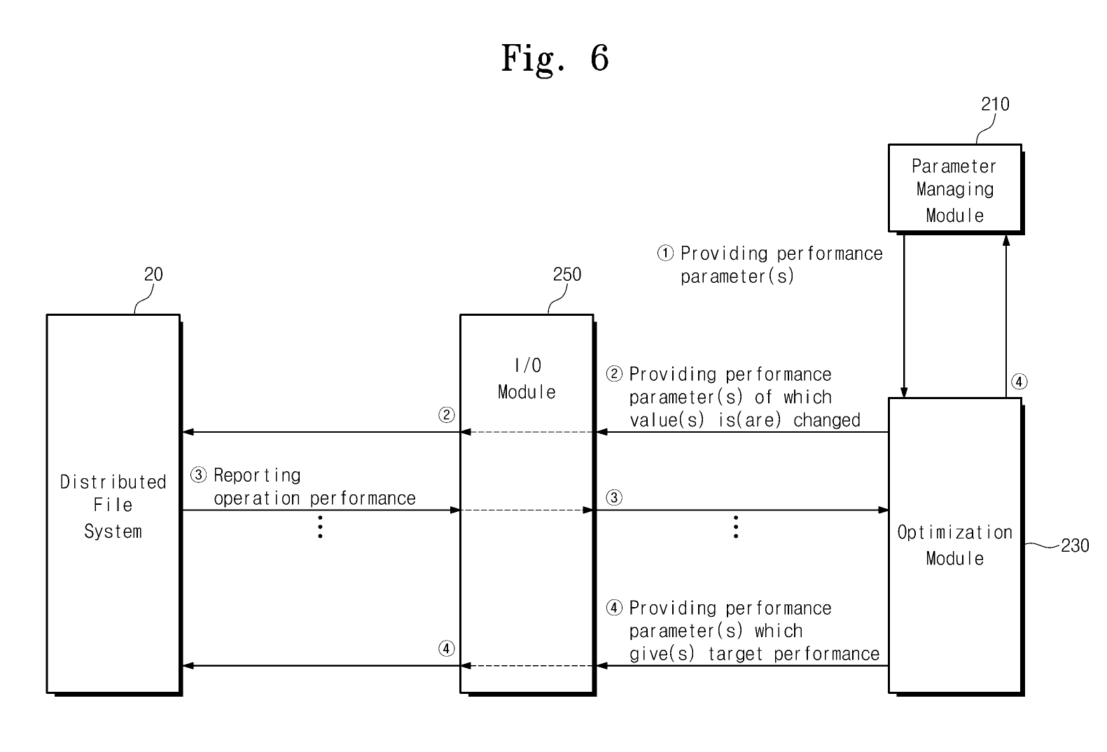

FIG. 6 is a schematic diagram for explaining an operation process of the device illustrated in FIG. 5. In particular, FIG. 6 describes a process in which the optimization module 230 improves the operation environment of the DFS 20.

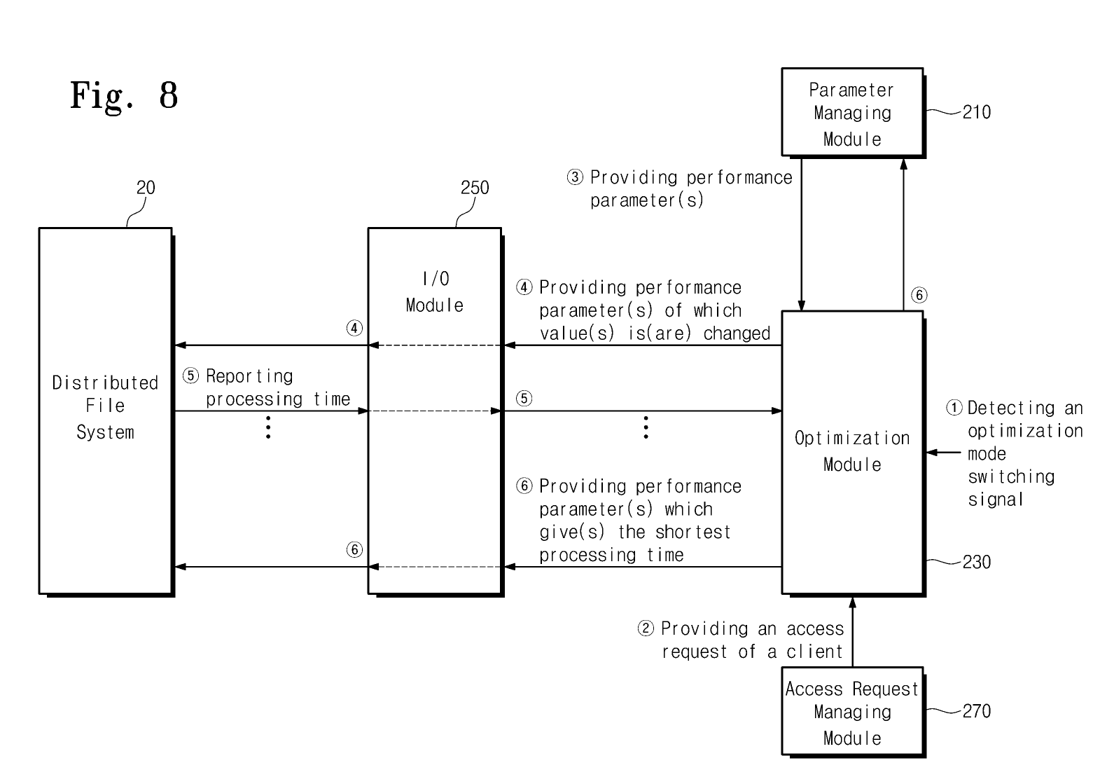

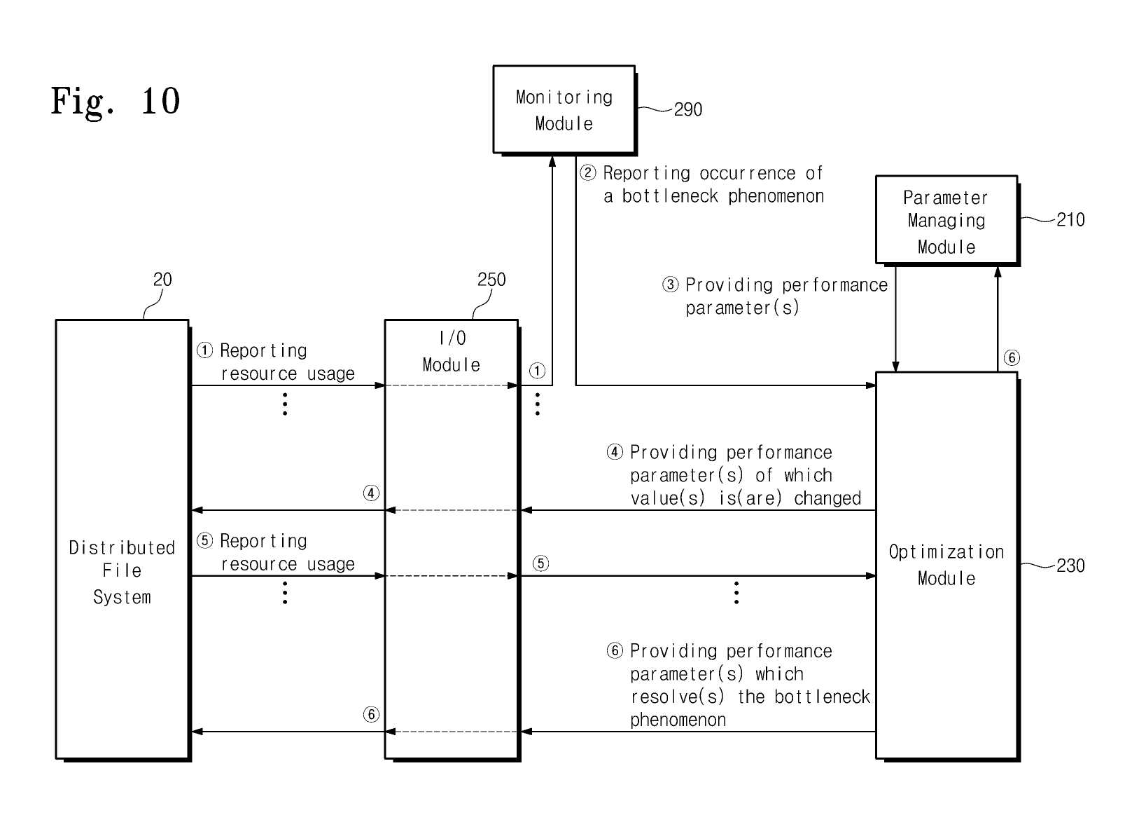

First, it may be determined whether a process for changing the operation environment of the DFS 20 is to be performed. Whether the process for changing the operation environment of the DFS 20 is to be performed may be determined based on whether a desired condition is satisfied. The desired condition may be satisfied when an optimization mode switching signal is detected. Alternatively, the desired condition may be satisfied when a bottleneck phenomenon occurs at the DFS 20. Some exemplary embodiments in relation to the desired condition will be further illustrated with reference to FIGS. 8 and 10.

When it is determined that the process for changing the operation environment of the DFS 20 is to be performed, the optimization module 230 may receive the value of each of the one or more performance parameters from the parameter managing module 210 (process \textcircled{1}). Then, the optimization module 230 may change the value of each of the one or more performance parameters received from the parameter managing module 210. The optimization module 230 may provide the changed value of each of the one or more performance parameters to the DFS 20 through the input/output module 250 (process \textcircled{2}). The operation environment of the DFS 20 may be changed based on the one or more performance parameters provided to the DFS 20.

The DFS 20 may provide information in relation to the operation performance being obtained in the changed operation environment to the optimization module 230 through the input/output module 250 (process \textcircled{3}). The optimization module 230 may determine whether the operation performance of the DFS 20 reaches the target performance based on the information in relation to the operation performance provided from the DFS 20. The target performance may be what the DFS processes an access request of a client in a short time. Alternatively, the target performance may be what the DFS 20 processes the access request of the client without a bottleneck phenomenon. The processes \textcircled{2} and \textcircled{3} may be repeatedly performed until the operation performance of the DFS 20 reaches the target performance.

The optimization module 230 may calculate the value of each of the one or more performance parameters that sets the operation environment having the target performance of the DFS 20 as the target value. The optimization module 230 may provide the one or more performance parameters having the calculated target value to the DFS 20 through the input/output module 250 (process \textcircled{4}). The operation environment of the DFS 20 may be changed based on the target value of each of the one or more performance parameters provided from the optimization module 230. The DFS 20 may operate at the target performance in the changed operation environment. However, in some exemplary embodiments, the optimization module 230 may generate the information of the calculated target value, instead of performing the process \textcircled{4}. Alternatively, the optimization module 230 may generate the information of the calculated target value while the process \textcircled{4} is being performed.

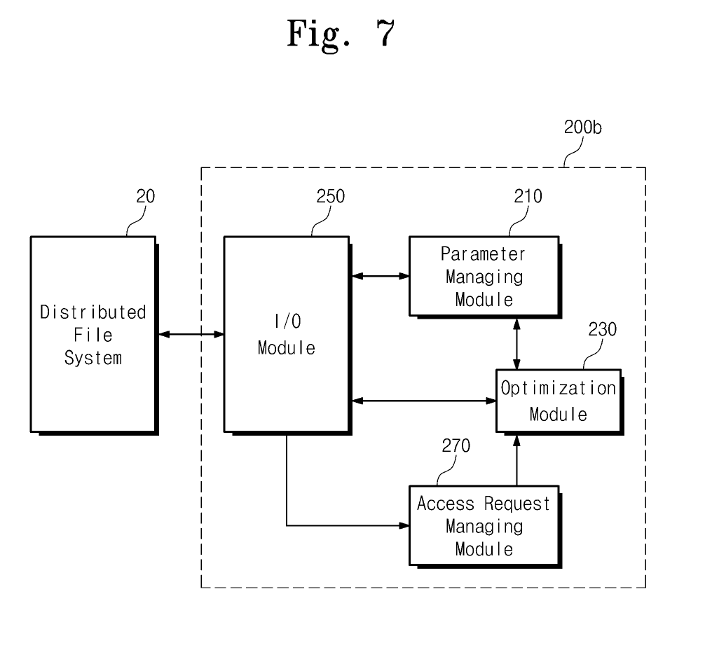

FIG. 7 is another block diagram illustrating a device for managing distributed file system in accordance with another embodiment. A distributed file system managing device 200b may include a parameter managing module 210, an optimization module 230, an input/output module 250, and an access request managing module 270. The distributed file system managing device 200b may communicate with the DFS 20.

Configurations and functions of the parameter managing module 210, the optimization module 230, and the input/output module 250 of the distributed file system managing device 200b may include configurations and functions of the parameter managing module 210, the optimization module 230, and the input/output module 250 of FIG. 5, respectively. The description of common features already discussed in FIG. 5 will be omitted for brevity.

The access request managing module 270 may receive information of an access request, of a client, with respect to data from the DFS 20 through the input/output module 250. If the access request with respect to the data occurs through the client, the access request managing module 270 may collect the information of the occurred access request. In some exemplary embodiments, the access request managing module 270 may include a storage area (not shown). The access request managing module 270 may store the collected information of the access request in the storage area.

The access request managing module 270 may manage the information of the access request. For instance, when the target value of each of the one or more performance parameters with respect to a specific access request is already calculated, the access request managing module 270 may remove the information with respect to the specific access request from the storage area.

FIG. 8 is a schematic diagram for explaining an operation process of the device illustrated in FIG. 7. In particular, FIG. 8 describes an optimization mode in which the optimization module 230 improves the operation environment of the DFS 20.

The optimization module 230 may detect an optimization mode switching signal (process \textcircled{1}). The optimization mode switching signal is for controlling the distributed file system managing device 200b such that the distributed file system managing device 200b operates in the optimization mode.

In some exemplary embodiments, the system manager may provide an optimization mode switching command to the DFS 20 and/or the distributed file system managing device 200b to improve the operation environment of the DFS 20. The optimization mode switching signal may be generated according to the optimization mode switching command of the system manager. The optimization mode switching signal may be generated according to the optimization mode switching command provided from the outside of the DFS 20 and the distributed file system managing device 200b. If the optimization mode switching command is provided to the DFS 20, the provided optimization mode switching command or the generated optimization mode switching signal may be provided to the optimization module 230 through the input/output module 250.

Alternatively, the optimization mode switching signal may be generated when a desired condition is satisfied. In some exemplary embodiments, the optimization mode switching signal may be generated when the access request with respect to the data is not provided from the client to the DFS 20 for a desired time. In other words, when the DFS 20 does not operate for the desired time (e.g., an idle time occurs), the optimization mode switching signal may be generated.

When the optimization mode switching signal is detected, the distributed file system managing device 200b may operate in an optimization mode. In the optimization mode, the optimization module 230 may receive the information of the access request, of the client, with respect to the data from the access request managing module 270 (process \textcircled{2}). Then, the optimization module 230 may receive the value of each of the one or more performance parameters from the parameter managing module 210 (process \textcircled{3}). The optimization module 230 may change the received value of each of the one or more performance parameters. Further, the optimization module 230 may provide the changed value of each of the one or more performance parameters and the same access request as the access request, of the client, with respect to the data to the DFS 20 through the input/output module 250 (process \textcircled{4}).

The operation environment of the DFS 20 may be changed based on the one or more performance parameters provided to the DFS 20. The DFS 20 may process the same access request of the client in the changed operation environment. The DFS 20 may provide information of a processing time of the same access request to the optimization module 230 through the input/output module 250 (process \textcircled{5}). The processes \textcircled{4} and \textcircled{5} may be repeatedly performed until the desired condition is satisfied. In other words, the same access request may be repeatedly processed in different operation environments of the DFS 20.

In some exemplary embodiments, the system manager may determine and set the value that each of the one or more performance parameters can have in advance. The set value may be stored in the parameter managing module 210. The processes \textcircled{4} and \textcircled{5} may be repeatedly performed until the same access request is processed in each and every operation environment of the DFS 20 of which each is differently set by the set value of each of the one or more performance parameters. In some exemplary embodiments, the system manager may determine and set a range of the value that each of the one or more performance parameters can have in advance. The set range may be stored in the parameter managing module 210. The processes \textcircled{4} and \textcircled{5} may be repeatedly performed until the same access request is processed in each and every operation environment of the DFS 20 of which each is differently set by values included in the set range.

The optimization module 230 may calculate the target value of each of the one or more performance parameters based on the information of the processing time of the same access. As an example, the operation environment corresponding to a case that the same access request is processed in the shortest time may be the operation environment having the target performance. The optimization module 230 may calculate the value of each of the one or more performance parameters of the case that the same access request is processed in the shortest time as the target value. After the DFS 20 processes the same access request whenever the value of each of the one or more performance parameters is changed, the value of each of the one or more performance parameters of the case that the same access request is processed in the shortest time may be calculated as the target value.

The optimization module 230 may provide the one or more performance parameters having the calculated target value to the DFS 20 and the parameter managing module 210 (process \textcircled{6}). Alternatively, the optimization module 230 may generate the information of the calculated target value, instead of performing the process \textcircled{6}. Of course, the optimization module 230 may generate the information of the calculated target value while the process \textcircled{6} is being performed.

The operation environment of the DFS 20 may be changed based on the target value of each of the one or more performance parameters. When the DFS 20 processes the same access request in the changed operation environment, the access request may be processed in a short time. In other words, the operation environment of the DFS 20 may be improved based on the target value of each of the one or more performance parameters.

Before the optimization module 230 operates in the optimization mode, different access requests, of the client, with respect to the data may occur several times. In this case, the optimization module 230 may calculate the target values of each of the one or more performance parameters with respect to each of multiple access requests as same as each of the different access requests in the optimization mode.

In some exemplary embodiments, when the target values of each of the one or more performance parameters with respect to each of the different access requests are all calculated, the optimization module 230 may stop an operation in the optimization mode and may begin to operate in a general mode. In some exemplary embodiments, when another access request with respect to the data is occurred by the client while the optimization module 230 is being operating in the optimization mode, the optimization module 230 may stop an operation in the optimization mode and may begin to operate in the general mode.

When the access request with respect to the data occurs by the client, the optimization module 230 may determine whether the target value of each of the one or more performance parameters with respect to the occurred access request is calculated. If the target value is calculated, the optimization module 230 may provide the one or more performance parameters having the calculated target value to the DFS 20 to change the operation environment of the DFS 20. The DFS 20 may rapidly process the access request, of the client, with respect to data in the changed operation environment.

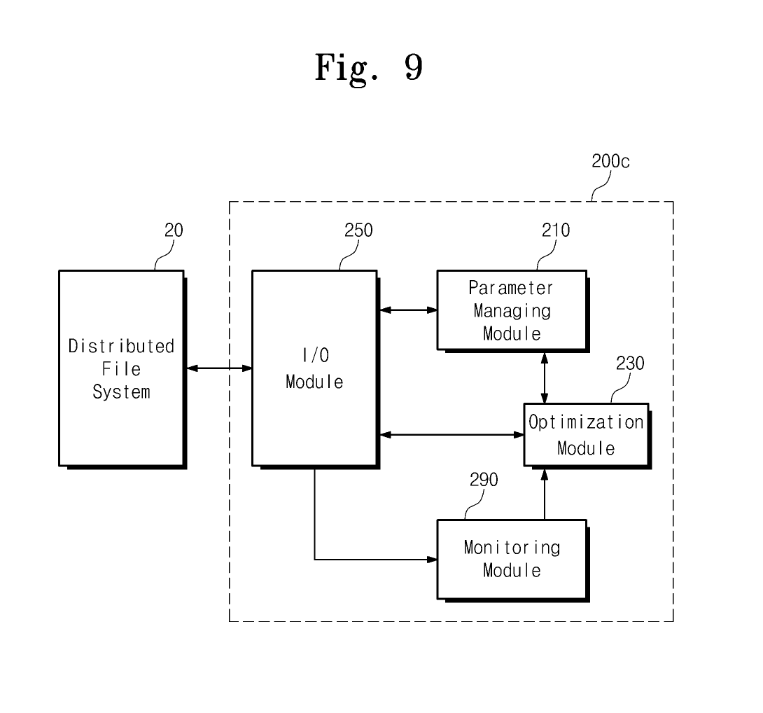

FIG. 9 is still another block diagram illustrating a device for managing distributed file system in accordance with another embodiment. A distributed file system managing device 200c may include a parameter managing module 210, an optimization module 230, an input/output module 250, and a monitoring module 290. The distributed file system managing device 200c may communicate with the DFS 20.

Configurations and functions of the parameter managing module 210, the optimization module 230, and the input/output module 250 of the distributed file system managing device 200c may include configurations and functions of the parameter managing module 210, the optimization module 230, and the input/output module 250 of FIG. 5, respectively. The description of common features already discussed in FIG. 5 will be omitted for brevity.

The monitoring module 290 may periodically receive information of resource usage of the DFS 20 from the DFS 20 through the input/output module 250 while the access request, of the client, with respect to the data is being processed. In exemplary embodiments, the DFS 20 may provide the information of the resource usage to the monitoring module 290 at a time interval of one minute while the access request is being processed. As an example, the resource usage may include a processor usage, a memory usage, and a transmission traffic rate through a network.

The monitoring module 290 may monitor whether a bottleneck phenomenon occurs in the DFS 20 based on the provided information of the resource usage. For instance, if a processor of the DFS 20 is completely used but a memory of at least one of the DFS 20 and the network is partially used, the processor of the DFS 20 may be determined to be a bottleneck point. If it is determined that the bottleneck point exists, it may be determined that the bottleneck phenomenon occurs.

FIG. 10 is a schematic diagram for explaining an operation process of the device illustrated in FIG. 9. Particularly, FIG. 10 describes a process that the optimization module 230 resolves the bottleneck phenomenon of the DFS 20.

The DFS 20 may provide the information of the resource usage to the monitoring module 290 through the input/output module 250 (process \textcircled{1}). The monitoring module 290 may periodically receive information of resource usage of the DFS 20 from the DFS 20 through the input/output module 250 while the access request, of the client, with respect to the data is being processed. The monitoring module 290 may monitor whether the bottleneck phenomenon occurs in the DFS 20 based on the received information of the resource usage. The process \textcircled{1} may be repeatedly performed until it is determined that the bottleneck phenomenon occurs.

If it is determined that the bottleneck phenomenon occurs, the monitoring module 290 may report an occurrence of the bottleneck phenomenon to the optimization module 230 (process \textcircled{2}). Then, the optimization module 230 may receive the value of each of the one or more performance parameters from the parameter managing module 210 (process \textcircled{3}). And then, the optimization module 230 may change the received value of each of the one or more performance parameters. Further, the optimization module 230 may provide the changed value of each of the one or more performance parameters to the DFS 20 through the input/output module 250 (process \textcircled{4}). The operation environment of the DFS 20 may be changed based on one or more performance parameters provided to the DFS 20.

The DFS 20 may provide the information of the resource usage obtained in the changed operation environment to the optimization module 230 through the input/output module 250 (process \textcircled{5}). The optimization module 230 may determine whether the bottleneck phenomenon which occurs in the DFS 20 is resolved based on the provided information of the resource usage. The processes \textcircled{4} and \textcircled{5} may be repeatedly performed until the bottleneck phenomenon which occurs in the DFS 20 is resolved.

The optimization module 230 may calculate the target value of each of the one or more performance parameters based on the provided information of the resource usage. For instance, the operation environment corresponding to a case that the bottleneck phenomenon is resolved may be the operation environment having the target performance. The optimization module 230 may calculate the value of each of the one or more performance parameters of the case that the bottleneck phenomenon which is occurred in the DFS 20 is resolved as the target value. The optimization module 230 may provide the one or more performance parameters having the calculated target value to the DFS 20 and the parameter managing module 210 through the input/output module 250 (process \textcircled{6}).

The operation environment of the DFS 20 may be improved based on the target value of each of the one or more performance parameters provided to the DFS 20. In other words, the bottleneck phenomenon which occurs in the DFS 20 may be resolved based on the target value of each of the one or more performance parameters. Alternatively, the optimization module 230 may generate the information of the calculated target value, instead of performing the process \textcircled{6}. The optimization module 230 may generate the information of the calculated target value while the process \textcircled{6} is being performed.

In FIGS. 5 to 10, the distributed file system managing devices 200a, 200b and 200c in which the parameter managing module 210, the optimization module 230, the input/output module 250, the access request managing module 270, and the monitoring module 290 are embodied by separate respective elements. However, these embodiments are just exemplary. As necessary, each of the parameter managing module 210, the optimization module 230, the input/output module 250, the access request managing module 270, and the monitoring module 290 may be embodied by being combined with other elements. Furthermore, the parameter managing module 210, the optimization module 230, the input/output module 250, the access request managing module 270, and the monitoring module 290 may be embodied by more subdivided elements according to their functions.

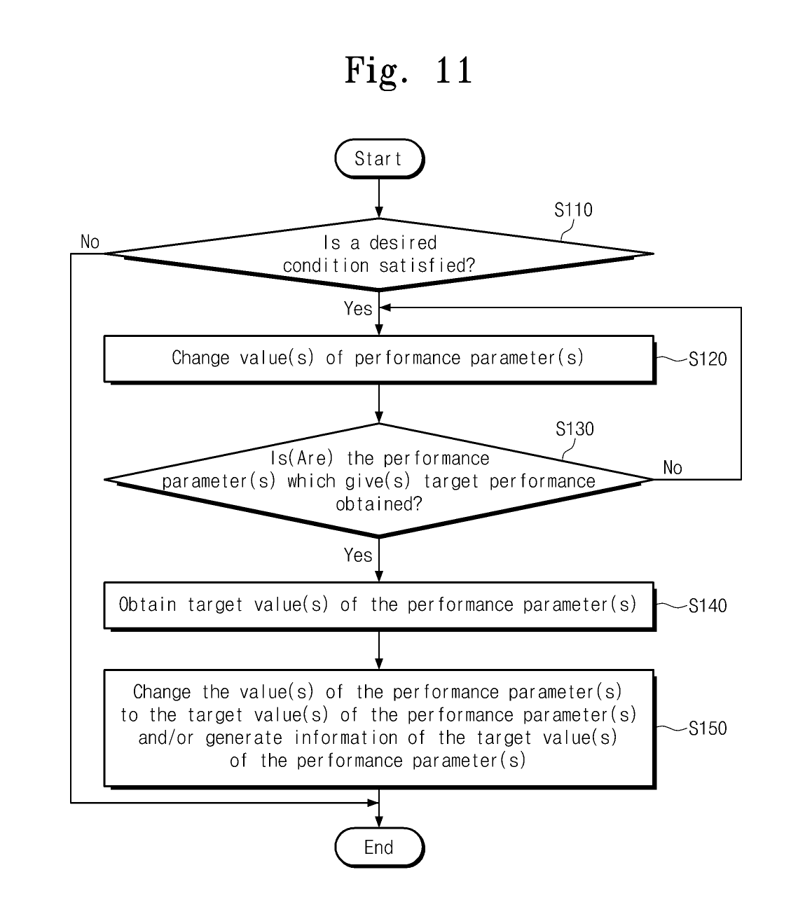

FIG. 11 is a flow chart illustrating an operating method of a distributed file system in accordance with still another embodiment. In particular, FIG. 11 describes a process for improving an operation environment of a DFS.

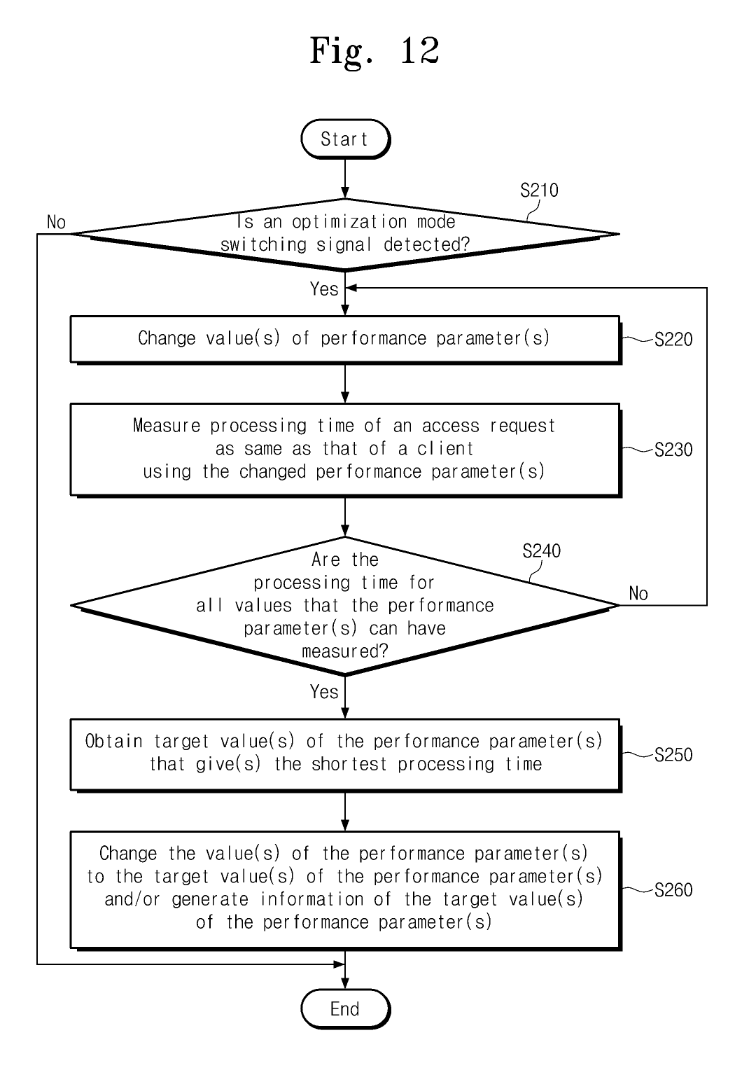

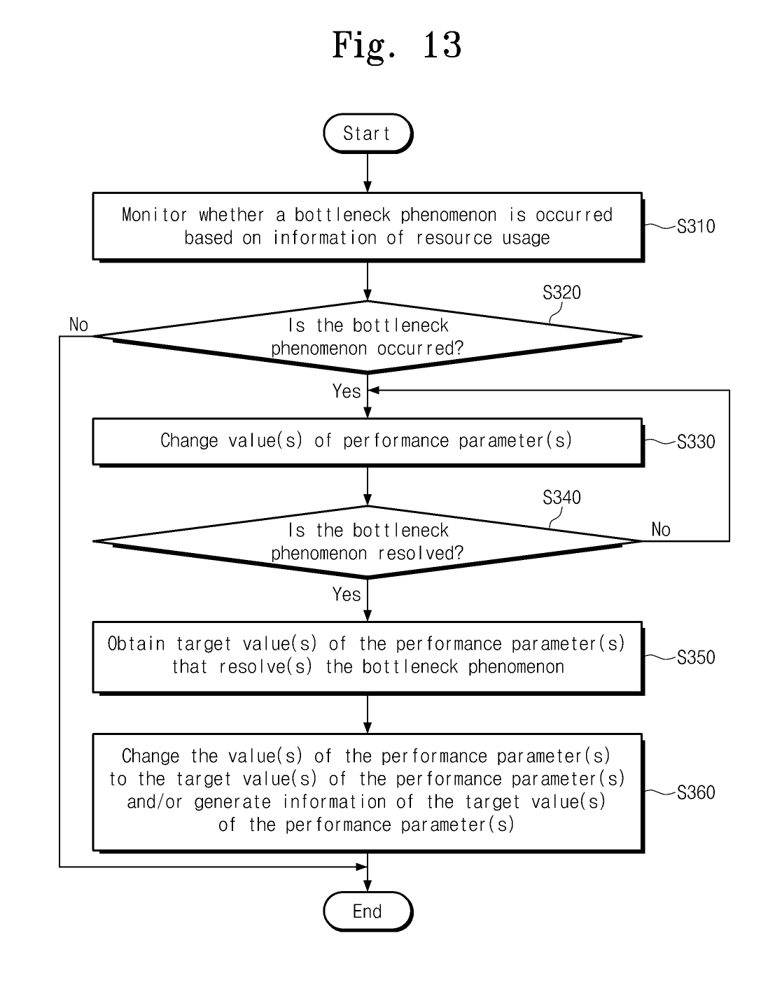

In a step S110, it may be determined whether a process for changing the operation environment of the DFS is to be performed. Whether the process for changing the operation environment of the DFS is to be performed may be determined based on whether a desired condition is satisfied. In other words, in the step S110, it may be determined whether the desired condition is satisfied. The desired condition may be satisfied when an optimization mode switching signal is detected. Alternatively, the desired condition may be satisfied a bottleneck phenomenon occurs in the DFS. Some exemplary embodiments in relation to the desired condition will be further illustrated with reference to FIGS. 12 and 13.

The operation environment of the DFS may be set by one or more parameters included in the DFS. The one or more parameters may include one or more performance parameters which are related with operation performance of the DFS. A change of the value of each of the one or more performance parameters may affect the operation performance of the DFS. If the desired condition is satisfied, a step S120 may be performed. However, if the desired condition is not satisfied, an operating method of the DFS may be terminated.

In the step S120, the value of each of the one or more performance parameters may be changed. If the value of each of the one or more performance parameters may be changed, the operation environment of the DFS may be changed. Further, information about the operation performance of the DFS operating in the changed operation environment may be obtained.

In a step S130, it may be determined whether the operation performance of the DFS reaches the target performance. In other words, it may be determined whether the one or more parameters that set the operation environment obtain the target performance. The target performance may be a performance in which the DFS processes an access request of a client in a short time. Alternatively, the target performance may be a performance in which the DFS processes the access request of the client without a bottleneck phenomenon.

If the operation performance of the DFS reaches the target performance, a step S140 may be performed. However, if the operation performance of the DFS does not reach the target performance, the step S120 may be performed. In other words, the steps S120 and S130 may be repeatedly performed until the operation environment having the target performance of the DFS is set.

In the step S140, the value of each of the one or more performance parameters that sets the operation environment having the target performance of the DFS may be calculated as a target value. The operation environment of the DFS may be improved by using the calculated target value. The calculated target value may be applied in a step S150.

In the step S150, the value of each of the one or more performance parameters may be changed to the target value calculated in the step S140. In other words, the operation environment of the DFS may be changed to the operation environment having the target performance based on the target value calculated in the step S140. Alternatively, information of the target value calculated in the step S140 may be generated. In other words, a log file is generated which is related with the calculated target value, or printed material or a pop-up message may be output. The information of the target value calculated in the step S140 may be generated while the operation environment of the DFS is being improved.

FIG. 12 is another flow chart illustrating an operating method of a distributed file system in accordance with still another embodiment. FIG. 12 describes an optimization mode for improving the operation environment of the DFS. Before the operating method of FIG. 12 is executed, information of an access request provided from a client to the DFS may be collected in advance.

In a step S210, it may be determined whether an optimization mode switching signal is detected. The optimization mode switching signal is for controlling the DFS such that the DFS operates in the optimization mode.

In some exemplary embodiments, a system manager may provide an optimization mode switching command to the DFS to improve the operation environment of the DFS. The optimization mode switching signal may be generated according to the optimization mode switching command of the system manager. In other words, the optimization mode switching signal may be generated according to the optimization mode switching command provided from the outside of the DFS.

In some exemplary embodiments, the optimization mode switching signal may be generated if a desired condition is satisfied. For instance, the optimization mode switching signal may be generated when the access request of the client is not provided to the DFS for a desired time. In other words, when the DFS does not operate for the desired time (e.g., an idle time occurs), the optimization mode switching signal may be generated.

When the optimization mode switching signal is detected, i.e., the DFS operates in the optimization mode, a step S220 may be performed. However, if the optimization mode switching signal is not detected, the operating method of the FIG. 12 may be terminated.

In the step S220, the value of each of the one or more performance parameters may be changed. When the value of each of the one or more performance parameters may be changed, the operation environment of the DFS may be changed.

In a step S230, the same access request as the access request of the client may be processed. Information about the access request of the client may be obtained from the information collected in advance. The same access request may be processed in the operation environment of the DFS which is changed based on the changed value of each of the one or more performance parameters obtained in the step S220. Meanwhile, a time may be measured that the same access request is processed in the changed operation environment of the DFS.

In step S240, it may be determined whether a processing time of the same access request with respect to each and every value that each of the one or more performance parameters can have is measured. If measured, a step S250 is performed. However, if not measured, the steps S220, S230 and S240 may be repeatedly performed. In other words, the same access request may be repeatedly performed in different operation environments of the DFS.

In some exemplary embodiments, a system manager may determine and set the value that each of the one or more performance parameters can have in advance. The steps S220, S230 and S240 may be repeatedly performed until the same access request is processed in each and every operation environment of the DFS of which each is differently set by the set value. In some exemplary embodiments, the system manager may determine and set a range of the value that each of the one or more performance parameters can have in advance. The steps S220, S230 and S240 may be repeatedly performed until the same access request is processed in each and every operation environment of the DFS of which each is differently set by values included in the set range.

In the step S250, a target value of each of the one or more performance parameters may be calculated based on the processing time of the same access request measured in the step S240. For instance, the operation environment corresponding to a case that the same access request is processed in the shortest time may be the operation environment having the target performance. The value of each of the one or more performance parameters of the case that the same access request is processed in the shortest time may be calculated as the target value. After the DFS processes the same access request whenever the value of each of the one or more performance parameters is changed, the value of each of the one or more performance parameters of the case that the same access request is processed in the shortest time may be calculated as the target value. The calculated target value may be applied in a step S260.

In the step S260, the value of each of the one or more performance parameters may be changed to the target value calculated in the step S250. In other words, the operation environment of the DFS may be changed to the operation environment having the target performance based on the target value calculated in the step S250. Alternatively, the information of the target value calculated in the step S250 may be generated. For instance, a log file is generated which is related with the calculated target value, or printed material or a pop-up message may be output. The information of the target value calculated in the step S250 may be generated while the operation environment of the DFS is being optimized.

The operation environment of the DFS may be changed based on the target value of each of the one or more performance parameters. When the DFS processes the access request of the client in the changed operation environment, the access request may be processed in a short time. In other words, the operation environment of the DFS may be improved based on the target value of one or more performance parameters.

FIG. 13 is still another flow chart illustrating an operating method of a distributed file system in accordance with still another embodiment. In particular, FIG. 13 describes a process for resolving a bottleneck phenomenon of the DFS.

In a step S310, it may be monitored whether the bottleneck phenomenon occurs in the DFS. Whether the bottleneck phenomenon occurs may be monitored based on information of resource usage of the DFS. In some exemplary embodiments, the resource usage may include a processor usage, a memory usage, and a transmission traffic rate through a network. The information of the resource usage may be periodically collected while the DFS is being processing an access request of a client.

In a step S320, it may be determined whether the bottleneck phenomenon occurs in the DFS. For instance, if a processor of the DFS is completely used but a memory of the DFS and the network is partially used, the processor of the DFS may be determined to be a bottleneck point. If it is determined that the bottleneck point exists, it may be determined that the bottleneck phenomenon occurs. If the bottleneck phenomenon occurs, a step S330 may be performed. However, when the bottleneck phenomenon does not occur, an operating method of FIG. 13 may be terminated.

In the step S330, the value of each of the one or more performance parameters may be changed. If the value of each of the one or more performance parameters may be changed, the operation environment of the DFS may be changed. Further, information about resource usage of the DFS operating in the changed operation environment may be obtained.

In a step S340, it may be determined whether the bottleneck phenomenon which occurs in the DFS is resolved. Whether the bottleneck phenomenon which occurs in the DFS is resolved may be determined based on the information of the resource usage of the DFS. If the bottleneck phenomenon is resolved, a step S350 may be performed. However, if the bottleneck phenomenon is not resolved, the step S330 may be performed. In other words, the steps S330 and S340 may be repeatedly performed until the bottleneck phenomenon is resolved.

In the step S350, the value of each of the one or more performance parameters that sets the operation environment having the target performance of the DFS may be calculated as a target value. In some exemplary embodiments, the operation environment of a case that the bottleneck phenomenon is resolved may be the operation environment having the target performance. In other words, the value of each of the one or more performance parameters of the case that the bottleneck phenomenon is resolved may be calculated as the target value. The bottleneck phenomenon which is occurred in the DFS may be resolved by using the calculated target value. The calculated target value may be applied in a step S360.

In the step S360, the value of each of the one or more performance parameters may be changed to the target value calculated in the step S350. In other words, the bottleneck phenomenon which occurs in the DFS may be resolved based on the target value calculated in the step S350. Alternatively, information of the target value calculated in the step S350 may be generated. For instance, a log file is generated which is relate with the calculated target value, or printed material or a pop-up message may be output. The information of the target value calculated in the step S350 may be generated while the bottleneck phenomenon which is occurred in the DFS is being resolved.

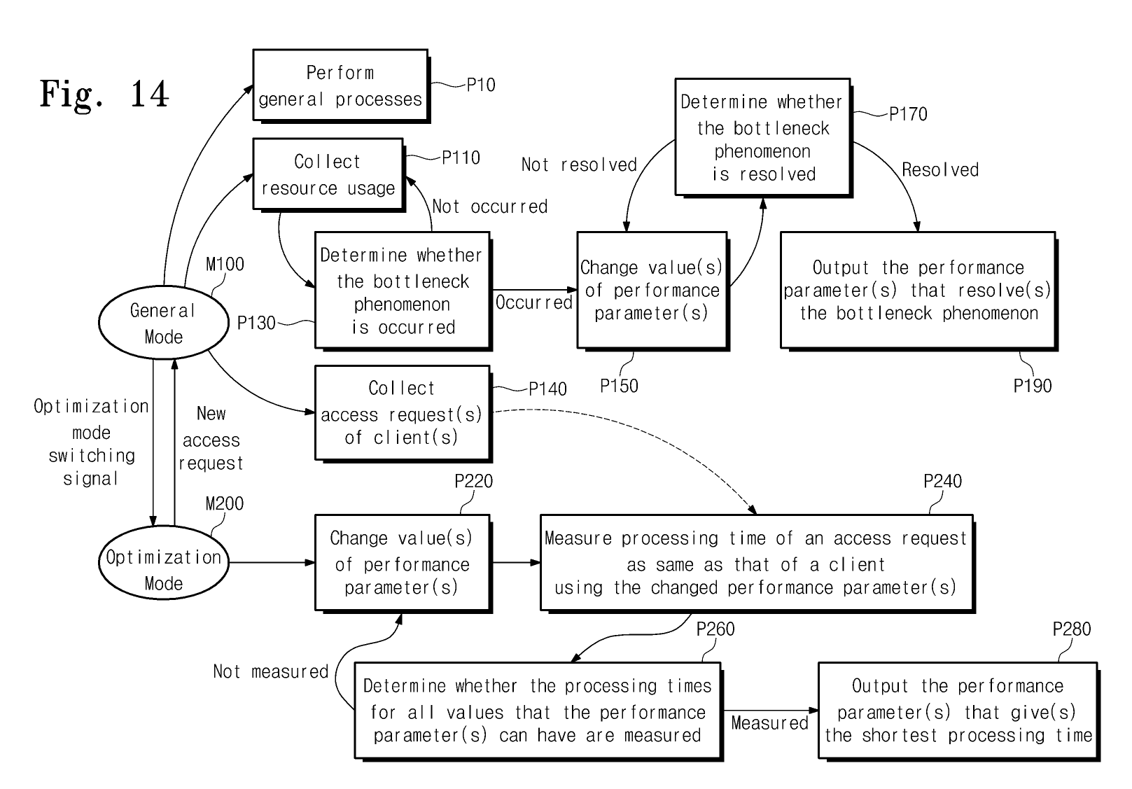

FIG. 14 is a flow chart for explaining a process being performed in a general mode and an optimization mode in accordance with exemplary embodiments of the inventive concept.

The DFS in accordance with exemplary embodiments of the inventive concept may operate in a general mode M100 or an optimization mode M200. When an optimization mode switching signal is generated while the DFS is being operating in the general mode M100, the DFS may begin to operate in the optimization mode M200. If an access request with respect to the DFS occurs by a client while the DFS is being operating in the optimization mode M200, the DFS may begin to operate in the general mode M100. However, this is just exemplary. A mode switching between the general mode M100 and the optimization mode M200 may occur according to other conditions.

General processes may be performed in the general mode M100 (P10). For instance, when a HDFS is used as the DFS, data may be processed by a MapReduce process. In other words, basic functions of the DFS may be performed in the general mode M100.

Information of resource usage of the DFS may be collected in the general mode M100 (P110). It may be determined whether a bottleneck phenomenon occurs in the DFS based on the collected information of the resource usage (P130). If the bottleneck phenomenon does not occur, the information of the resource usage of the DFS may be collected again (P110). However, if the bottleneck phenomenon occurs, a value of each of one or more performance parameters, which are related with an operation performance of the DFS among one or more parameters that set the operation environment of the DFS, may be changed (P150).

If the value of each of the one or more performance parameters is changed, the operation environment of the DFS may be changed. It may be determined whether the bottleneck phenomenon of the DFS operating in the changed operation environment is resolved (P170). If the bottleneck phenomenon is not resolved, the value of each of the one or more performance parameters may be changed again (P150). However, if the bottleneck phenomenon is resolved, the value of each of the one or more performance parameters that sets the operation environment of the DFS in which the bottleneck phenomenon is resolved may be calculated as a target value (P190). The processes P110, P130, P150, P170, and P190 may be performed by the same method as described in FIGS. 4, 10 and 13.

Further, in the general mode M100, information of the access request, of the client, with respect to the DFS may be collected (P140). The collected information of the access request may be applied in the optimization mode M200.

In the optimization mode M200, the value of each of the one or more performance parameters may be changed. The DFS may process the same access request as the access request of the client in the operation environment changed based on the changed value of each of the one or more performance parameters. The information of the access request, of the client, with respect to the DFS may be obtained from the information of the access request collected in the P140. Further, a processing time of the same access request may be measured (P240).

It may be determined whether a processing time of the same access request is measured with respect to each and every value that each of the one or more performance parameters may have (P260). If not measured, the value of each of the one or more performance parameters may be changed again (P220). In other words, the same access request may be repeatedly processed in different operation environments of the DFS. However, if measured, the value of each of the one or more performance parameters which sets the operation environment of the DFS processing the same access request in the shortest time may be calculated as the target value (P280). The processes P140, P220, P240, P260, and P280 may be performed by the same method as described in FIGS. 3, 8, and 12.

The embodiment of FIG. 14 is only an illustration and an operation mode of the DFS may be changed in various forms. Furthermore, processes which are performed in each operation mode may be varied as necessary.

The DFS in accordance with exemplary embodiments of the inventive concept may include an optimization unit or a distributed file system managing device. In exemplary embodiments of the inventive concept, the optimization unit or the distributed file system managing device may calculate a target value of a performance parameter to improve an operation environment of the DFS. According to exemplary embodiments of the inventive concept, the DFS may perform a configuration process of a performance parameter for itself. Thus, a burden of a system manager may be reduced. According to exemplary embodiments of the inventive concept, an operation environment having target performance of the DFS may be set. Thus, data having a large size may be processed more effectively and rapidly using the DFS in accordance with exemplary embodiments of the inventive concept.

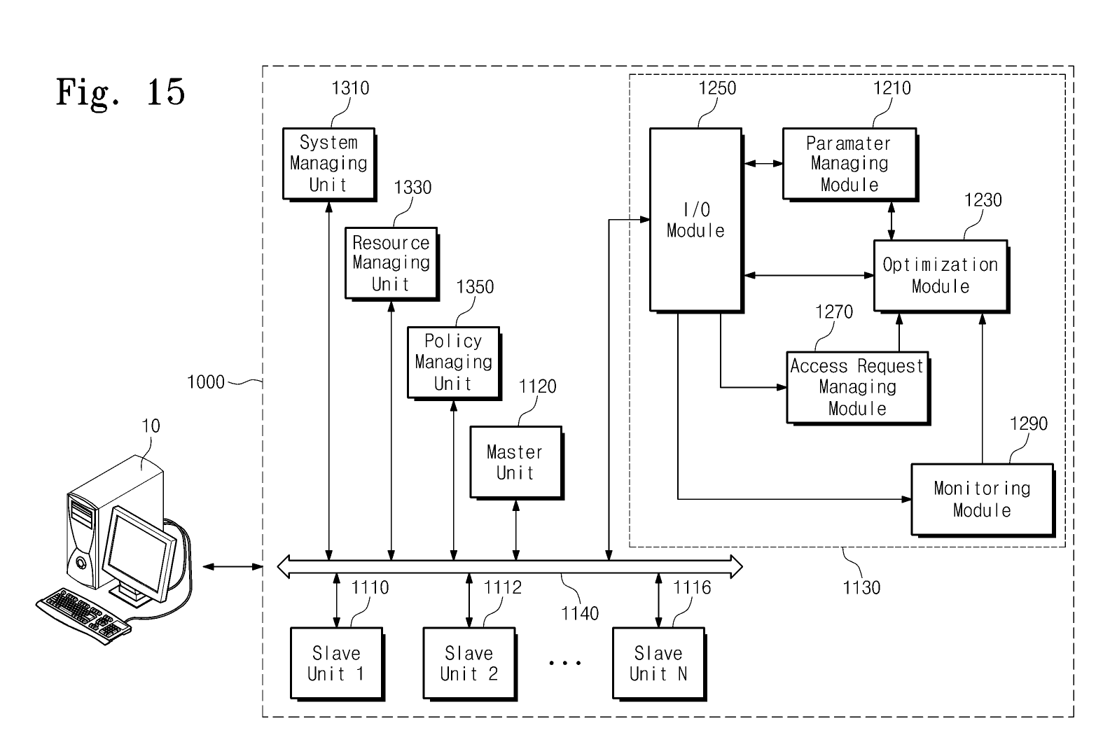

FIG. 15 is a block diagram illustrating a cloud storage system adopting a distributed file system in accordance with the exemplary embodiments. A cloud storage system 1000 may include a plurality of slave units 1110, 1112, and 1116, a master unit 1120, an optimization unit 1130, a network 1140, a system managing unit 1310, a resource managing unit 1330, and a policy managing unit 1350. The optimization unit 1130 may include a parameter managing module 1210, an optimization module 1230, an input/output module 1250, an access request managing module 1270, and a monitoring module 1290. The cloud storage system 1000 may communicate with a client 10.

Configurations and functions of the slave units 1110, 1112 and 1116, the master unit 1120, the optimization unit 1130 and the network 1140 may include configurations and functions of the slave units 110, 112 and 116, the master unit 120, the optimization unit 130 and the network 140 of FIGS. 1 to 4, respectively. Configurations and functions of the parameter managing module 1210, the optimization module 1230, the input/output module 1250, the access request managing module 1270, and the monitoring module 1290 may include configurations and functions of the parameter managing module 210, the optimization module 230, the input/output module 250, the access request managing module 270, and the monitoring module 290 of FIGS. 5 to 10, respectively.

The system managing unit 1310 may control and manage the overall operation of the cloud storage system 1000. The resource managing unit 1330 may manage resource usage of each element of the cloud storage system 1000. The policy managing unit 1350 may manage a policy with respect to an access to the cloud storage system 1000 by the client 10, and may control the access of the client 10. The system managing unit 1310, the resource managing unit 1330, and the policy managing unit 1350 may exchange information with other elements through the network 1140.

A configuration of the cloud storage system 1000 illustrated in FIG. 15 is just exemplary. The cloud storage system 1000 adopting a technical spirit of the exemplary embodiments may be configured in a different form. Some elements illustrated in FIG. 15 may be excluded from the cloud storage system 1000, or other elements not illustrated in FIG. 15 may be further included in the cloud storage system 1000. Furthermore, each element illustrated in FIG. 15 may be embodied by being combined with other elements as necessary, or each element illustrated in FIG. 15 may be embodied by further subdivided elements according to its function.

According to another exemplary embodiment, a parameter managing module 210, an optimization module 230, and input/output module 250, an access request managing module 270, and a monitoring module 290 may include at least one processor, a hardware module, or a circuit for performing their respective functions.

The foregoing is illustrative of the inventive concept and is not to be construed as limiting thereof. Although a few exemplary embodiments of the inventive concepts have been described, those skilled in the art will readily appreciate that many modifications are possible in the exemplary embodiments without materially departing from the novel teachings and advantages of the exemplary embodiments. Accordingly, all such modifications are intended to be included within the scope of the present invention as defined in the claims. The exemplary embodiments are defined by the following claims, with equivalents of the claims to be included therein.

What is claimed is:

1. A distributed computing system configured to drive a distributed file system, the distributed file system configured to divide data into a plurality of data blocks to dispersively store each data block, the distributed computing system comprising:
a plurality of slave devices, wherein at least one slave device of the plurality of slave devices is configured to perform a first operation to dispersively store each of the plurality of data blocks;
a master device configured:
to perform a second operation to divide the data into the plurality of data blocks;
to provide each of the plurality of data blocks to each of the at least one slave device;
to manage distributed storage information about the plurality of data blocks; and
to process an access request, provided from a client, with respect to the data; and
an optimization device configured to calculate a target value of each of at least one performance parameter of the master device and each of the plurality of slave devices,
wherein the target value sets an operation environment with a target performance of the master device and each of the plurality of slave devices,
wherein the target value is calculated by repeatedly changing a value of each of the at least one performance parameter until the operation environment with the target performance is set.

2. The distributed computing system of claim 1, wherein the at least one performance parameter comprises at least one parameter previously selected from among the at least one parameter for setting an operation environment of the master device and each of the plurality of slave devices, or at least one parameter arbitrarily selected by the optimization device.

3. The distributed computing system of claim 1, wherein, in response to an optimization mode switching signal being detected, the optimization device is further configured to provide a same access request as the access request to the master device, while providing a changed value of each of the at least one performance parameter to at least one of the master device and each of the plurality of slave devices by repeatedly changing the value of each of the at least one performance parameter until a desired condition is satisfied, and to calculate the changed value of each of the at least one performance parameter in a case that the same access request is processed in a shortest time as the target value.

4. The distributed computing system of claim 3, wherein the optimization mode switching signal is generated based on an optimization mode switching command provided external from the optimization device, or is generated in response to the access request not being provided from the client to the master device for a desired time.

5. The distributed computing system of claim 3, wherein the desired condition is satisfied in response to measuring each and every processing time of the same access request corresponding to each and every value that the at least one performance parameter is capable of having, or is satisfied in response to measuring each and every processing time of the same access request corresponding to a predetermined range of values that the at least one performance parameter is capable of having.

6. The distributed computing system of claim 1, wherein the optimization device is further configured to monitor whether a bottleneck phenomenon occurs in at least one device of the master device and each of the plurality of slave device based on information of resource usage of the master device and each of the plurality of slave devices during a process of the access request, to provide a changed value of each of the at least one performance parameter to at least one device of the master device and each of the plurality of slave devices by repeatedly changing the value of each of the at least one performance parameter until the bottleneck phenomenon is resolved, in response to the bottleneck phenomenon occurring, and to calculate the changed value of each of the at least one performance parameter for a case that the bottleneck phenomenon is the target value.

7. The distributed computing system of claim 1, wherein the optimization device is further configured to change the operation environment of the master device and each of the plurality of slave devices to the operation environment having the target performance, according to the calculated target value, or to generate information about the calculated target value.

8. A device for managing a distributed file system, the distributed file system configured to divide data into a plurality of data blocks to dispersively store each data block, the device comprising:
a parameter managing module configured to manage a value of each of at least one performance parameter selected from among at least one parameter, the at least one parameter setting an operation environment of the distributed file system;
an optimization module configured to calculate a target value of each of the at least one performance parameter, the target value setting an operation environment with a target performance of the distributed file system, the target value calculated by repeatedly changing the value of each of the at least one performance parameter until the operation environment having the target performance is set; and
an input and output module configured to provide information generated in the distributed file system to at least one of the parameter managing module and the optimization module, or to provide information generated in the at least one of the parameter managing module and the optimization module to the distributed file system.

9. The device of claim 8, wherein the at least one performance parameter comprises at least one parameter previously selected from among the one or more parameters, or at least one parameter arbitrarily selected by the optimization module.

10. The device of claim 8, further comprising:
an access request managing module configured to receive information about an access request, provided from a client to the distributed file system, with respect to the data through the input and output module from the distributed file system, and to manage the received information about the access request.

11. The device of claim 10, wherein, in response to an optimization mode switching signal being detected, the optimization module is further configured to provide a same access request as the access request and a changed value of each of the at least one parameter, through the input and output module to the distributed file system, by repeatedly changing the value of each of the at least one performance parameter until a desired condition is satisfied, and to calculate the changed value of each of the at least one performance parameter in a case that the same access request is processed in a shortest time as the target value.

12. The device of claim 8, further comprising:
a monitoring module configured to receive information about resource usage of the distributed file system during a process of the access request, from the distributed file system through the input and output module, and to monitor whether a bottleneck phenomenon occurs in the distributed file system based on the received information about resource usage.

13. The device of claim 12, wherein the optimization module is further configured to provide a changed value of each of the at least one performance parameter, through the input and output module to the distributed file system, by repeatedly changing the value of each of the at least one performance parameter until the bottleneck phenomenon is resolved, in response to the bottleneck phenomenon occurring, and to calculate the changed value of each of the at least one performance parameter for a case that the bottleneck phenomenon is the target value.

14. The device of claim 8, wherein the optimization module is further configured to change the operation environment of the distributed file system to the operation environment having the target performance, according to the calculated target value, or to generate information about the calculated target value.

15. An operating method of a distributed file system, the method comprising:
determining whether a bottleneck phenomenon occurs based on information about a resource usage in the distributed file system;
changing at least one value of at least one performance parameter of a plurality of performance parameters in response to determining that the bottleneck phenomenon occurs;
obtaining the at least one value of the at least one performance parameter as a target value in response to determining that the changed at least one value of the at least one performance parameter resolves the bottleneck phenomenon; and
changing each of the plurality of parameters to the target value of the at least one performance parameter.

16. The method of claim 15, further comprising:
repeatedly changing the at least one value of the at least one performance parameter in response to determining that the changed at least one value of the at least one performance parameter does not resolve the bottleneck phenomenon.

17. The method of claim 15, wherein the resource usage comprises at least one of a processor usage, a memory usage, and a transmission traffic usage through a network of the distributed file system.

18. The method of claim 15, wherein in response to the changing the at least one value of the at least one performance parameter, an operating environment of the distributed file system is changed and updated information about the resource usage is obtained.

19. The method of claim 15, wherein the information about the resource usage is periodically collected during the determining whether the bottleneck phenomenon occurs.
